(19) United States
(12) Patent Application Publication
(10) Pub. No.: US 2022/0049097 A1
(43) Pub. Date: Feb. 17, 2022

(54) SILICONE RUBBER COMPOSITION

(71) Applicant: DOW SILICONES CORPORATION, Midland, MI (US)

(72) Inventors: Robert A. DRAKE, Barry, Wales (GB); Hans Peter WOLF, Wiesbaden (DE); Xao Phung SCHENK, Wiesbaden (DE); Patrick BEYER, Wiesbaden (DE)

(21) Appl. No.: 17/278,888

(22) PCT Filed: Sep. 19, 2019
(86) PCT No.: PCT/US2019/051813

§ 371 Date: Mar. 23, 2021

Related U.S. Application Data
(60) Provisional application No. 62/832,445, filed on Apr. 11, 2019.
(60) Provisional application No. 62/735,412, filed on Sep. 24, 2018.

(51) Int. Cl. C08L 83/04; C08G 77/12; C08G 77/20; C08G 77/24; C08K 3/36; C08K 9/06; C08K 5/14; H01B 3/46

(52) U.S. Cl. CPC C08L 83/04; C08G 77/12; C08G 77/20; C08G 77/24; C08K 3/36; C08K 9/06; C08K 2201/001; H01B 3/46; C08L 2205/02; C08L 2205/03; C08L 2203/20; C08L 2203/30; C08K 5/14

(57) ABSTRACT

A silicone based composition comprises a blend of a non-fluorinated polydiorganosiloxane polymer and a fluorinated polydiorganosiloxane polymer. The composition is useful in the manufacture of insulators for high voltage direct current (HVDC) applications and accessories such as cable joints, cable terminal applications, and connectors. In general, the composition is a curable silicone elastomer composition comprising: (A) a combination of (A)(i) and (A)(ii), where (A)(i) is a non-fluorinated polydiorganosiloxane in an amount of from 50 to 99.5% by weight of component (A) and (A)(ii) is a fluorinated polydiorganosiloxane polymer in an amount of from 0.5 to 50% by weight of component (A); (B) at least one reinforcing filler; and at least one of (C) or (D), where (C) is at least one organohydrogenpolysiloxane (C)(i), at least one hydrosilylation catalyst (C)(ii), and optionally at least one cure inhibitor (C)(iii); or (D) at least one peroxide catalyst.

The present disclosure relates to the use of a silicone based composition comprising a blend of a non-fluorinated polydiorganosiloxane polymer and a fluorinated polydiorganosiloxane polymer in the manufacture of insulators for high voltage direct current (HVDC) applications and accessories such as cable joints, cable terminal applications, and connectors.

Whilst, in most instances, alternating current (AC) is preferred for the supply of electricity to end users, long distance power transmission for distances e.g. >1000 km, may be undertaken using high voltage direct current (HVDC) systems because it involves lower electrical loss and therefore can be less expensive. Long distance HVDC transmission is generally undertaken in three ways, overhead e.g. via pylons; through underground systems and where necessary via “submarine” systems for transportation under the sea etc. It is probably fair to say that underground systems are significantly more aesthetically pleasing to the general public than pylons as the latter, whilst practical, can be considered an eyesore. However, underground HVDC transmission is the most challenging for the supplier as it generally involves the use of cable joints every 1 to 2 km compared to overhead and submarine systems. Hence, whilst many cable joints are required for any sort of HVDC transmission, the requirement is particularly acute in the case of underground systems.

However, the insulating materials utilised with respect to AC current transmission systems are typically not transferrable to direct current transmission systems because electrical stress is significantly different for AC and DC conditions, not least because the insulating material is exposed to a higher continuous electrical stress under DC conditions which can lead to a dielectric breakdown of materials. Dealing with such matters is becoming particularly important today given industry HVDC voltage requirements for new cables and cable accessories keep increasing and can now be >500 kV or even >800 kV. Liquid silicone rubber (LSR) compositions which, apart from EPDM, are generally the preferred insulating materials for the manufacture of HVDC cable joints and other accessories, are excellent electrical insulators once cured into a final product and typically have a resistivity ≥10¹⁵ ohm cm.

However, they can be “too good” as insulators in that the electrical field can't be distributed within the insulator.

Hence the HVDC places too great an electrical stress on the silicone based insulating materials due to the increased local loadings when compared to AC insulation. Generally, the industry has addressed this issue by introducing conductive fillers (e.g. carbon blacks or carbon nanotubes) thermally-conductive fillers or semi conductive fillers into the compositions to render them sufficiently conductive to enable the distribution of local DC loadings through a marginally conductive silicone elastomeric product made from a conductive LSR composition providing a bulk resistivity in the range 10¹⁰ to 10¹⁵ ohm cm.

However, whilst this solution is able to solve the distribution issue the introduction of such fillers can create further issues, not least an inability to control and or obtain uniform electrical properties within a silicone elastomer particularly with respect to uses of conductive fillers and a worsening of physical properties and reduced dielectric strength when relying on said conductive fillers, thermally-conductive or semi conductive fillers.

It has now been determined that the need to introduce said conductive and/or semi-conductive fillers can be avoided by using a blend of a non-fluorinated polydiorganosiloxane polymer and a fluorinated polydiorganosiloxane polymer in a composition for the manufacture of insulators for high voltage direct current application.

There is provided a use of a curable silicone elastomer composition comprising

(A) a combination of (A)(i) and (A)(ii) wherein
(A)(i) is a non-fluorinated polydiorganosiloxane in an amount of from 50 to 99.5% by weight of component A and
(A)(ii) a fluorinated polydiorganosiloxane polymer in an amount of from 0.5 to 50% by weight of component A;
(B) at least one reinforcing filler; and at least one of (C) or (D) wherein
(C) is at least one organohydrogenpolysiloxane (C)(i), at least one hydrosilylation catalyst (C)(ii) and optionally at least one cure inhibitor (C)(iii); or
(D) at least one peroxide catalyst;
which composition contains ≤0.1% by weight of the composition of conductive filler or semi conductive filler or a mixture thereof; in or as a high voltage direct current insulator.

In one embodiment the composition described above contains 0 (zero) % by weight of conductive filler. When (C), a hydrosilylation cure package, is present in the composition at least non-fluorinated polydiorganosiloxane (A)(i) and optionally fluorinated polydiorganosiloxane (A)(ii) must contain at least one, alternatively at least two alkenyl or alkynyl groups per molecule.

There is also provided a curable silicone elastomer composition comprising (A) a blend of (A)(i) and (A)(ii) wherein

(A)(i) is a non-fluorinated polydiorganosiloxane, in an amount of from 50 to 99.5% by weight of component A and
(A)(ii) a fluorinated polydiorganosiloxane polymer in an amount of from 0.5 to 50% by weight of component A;
(B) at least one reinforcing filler; and at least one of (C) or (D) wherein
(C) is at least one organohydrogenpolysiloxane (C)(i), at least one hydrosilylation catalyst (C)(ii) and optionally at least one cure inhibitor (C)(iii); or
(D) at least one peroxide catalyst;
which composition contains ≤0.1% by weight of the composition of conductive filler or semi conductive filler or a mixture thereof.

In one embodiment the composition described above contains 0 (zero) % by weight of conductive filler. When (C), a hydrosilylation cure package, is present in the composition at least non-fluorinated polydiorganosiloxane (A)(i) and optionally fluorinated polydiorganosiloxane (A)(ii) must contain at least one, alternatively at least two alkenyl or alkynyl groups per molecule.

There is also provided a high voltage direct current insulator comprising an elastomeric product of a curable silicone elastomer composition comprising (A) a combination of (A)(i) and (A)(ii) wherein

(A)(i) is a non-fluorinated polydiorganosiloxane polymer in an amount of from 50 to 99.5% by weight of component A and
(A)(ii) a fluorinated polydiorganosiloxane polymer in an amount of from 0.5 to 50% by weight of component A;
(B) at least one reinforcing filler; and at least one of (C) or (D) wherein
(C) is at least one organohydrogenpolysiloxane (C)(i), at least one hydrosilylation catalyst (C)(ii) and optionally at least one cure inhibitor (C)(iii); or
(D) at least one peroxide catalyst;
which composition contains ≤0.1% by weight of the composition of conductive filler or semi conductive filler or a mixture thereof.

In one embodiment the composition herein contains 0 (zero) % by weight of conductive filler. When (C) a hydrosilylation cure package is present in the composition at least non-fluorinated polydiorganosiloxane (A)(i) and optionally fluorinated polydiorganosiloxane (A)(ii) must contain at least one, alternatively at least two alkenyl or alkynyl groups per molecule.

In a still further embodiment there is provided a high voltage direct current insulator comprising an elastomeric product obtained by curing silicone elastomer composition comprising (A) a blend of (A)(i) and (A)(ii) wherein

(A)(i) is a non-fluorinated polydiorganosiloxane in an amount of from 50 to 99.5% by weight of component A and
(A)(ii) a fluorinated polydiorganosiloxane polymer having in an amount of from 0.5 to 50% by weight of component A;
(B) at least one reinforcing filler; and at least one of (C) or (D) wherein
(C) is at least one organohydrogenpolysiloxane (C)(i), at least one hydrosilylation catalyst (C)(ii) and optionally at least one cure inhibitor (C)(iii); or
(D) at least one peroxide catalyst;
which composition contains ≤0.1% by weight of the composition of conductive filler or semi conductive filler or a mixture thereof.

In one embodiment the composition herein contains 0 (zero) % by weight of conductive filler. When (C) a hydrosilylation cure package is present in the composition at least non-fluorinated polydiorganosiloxane (A)(i) and optionally fluorinated polydiorganosiloxane (A)(ii) must contain at least one, alternatively at least two alkenyl or alkynyl groups per molecule.

For the purpose of this application “Substituted” means one or more hydrogen atoms in a hydrocarbon group has been replaced with another substituent. Examples of such substituents include, but are not limited to, halogen atoms such as chlorine, bromine, and iodine; halogen atom containing groups (other than fluoro) such as chloromethyl; oxygen atoms; oxygen atom containing groups such as (meth)acrylic and carboxyl; nitrogen atoms; nitrogen atom containing groups such as amino-functional groups, amido-functional groups, and cyano-functional groups; sulphur atoms; and sulphur atom containing groups such as mercapto groups.

The siloxane polymer (A) used in the composition above is a combination of (A)(i) and (A)(ii) which when together in the relative amounts indicated have been found to function, when cured with the other ingredients of the composition, as an insulator suitable for use in high voltage direct current applications. Component (A) is a combination of

(A)(i) a non-fluorinated polydiorganosiloxane in an amount of from 50 to 99.5% by weight of component (A) and
(A)(ii) a fluorinated polydiorganosiloxane in an amount of from 0.5 to 50% by weight of component (A).

When (C) the hydrosilylation cure package is present in the composition at least non-fluorinated polydiorganosiloxane (A)(i) and optionally fluorinated polydiorganosiloxane (A)(ii) must contain at least one, alternatively at least two alkenyl or alkynyl groups per molecule. However, when component (D) is the only means of catalysis for the cure process the presence of at least one alkenyl or alkynyl group per molecule alternatively at least two alkenyl or alkynyl groups per molecule in (A)(i) and (A)(ii) is preferred but is not essential.

Hence, preferably component(s) (A)(i) must contain at least one, alternatively at least two alkenyl or alkynyl groups per molecule and component (A)(ii) may, if required contain at least one, alternatively at least two alkenyl or alkynyl groups per molecule but alternatively may contain no unsaturated groups e.g. alkenyl and/or alkynyl groups per molecule. Alternatively, in one embodiment both components (A)(i) and (A)(ii) must contain at least one, alternatively at least two alkenyl or alkynyl groups per molecule.

Non-fluorinated polydiorganosiloxane polymer (A)(i), is present in an amount of from 50 to 99.5% by weight of component (A) and has multiple units of the formula (I):

RₐSiO_{(4-a)/2} (I)

in which each R is independently selected from an aliphatic hydrocarbyl, aromatic hydrocarbyl, or organyl group (that is any organic substituent group, regardless of functional type, having one free valence at a carbon atom). Saturated aliphatic hydrocarbyls are exemplified by, but not limited to alkyl groups such as methyl, ethyl, propyl, pentyl, octyl, undecyl, and octadecyl and cycloalkyl groups such as cyclohexyl. Unsaturated aliphatic hydrocarbyls are exemplified by, but not limited to, alkenyl groups such as vinyl, allyl, butenyl, pentenyl, cyclohexenyl and hexenyl; and by alkynyl groups. Aromatic hydrocarbon groups are exemplified by, but not limited to, phenyl, tolyl, xylyl, benzyl, styryl, and 2-phenylethyl. Organyl groups are exemplified by, but not limited to, halogenated alkyl groups (excluding fluoro containing groups) such as chloromethyl and 3-chloropropyl; nitrogen containing groups such as amino groups, amido groups, imino groups, imido groups; oxygen containing groups such as polyoxyalkylene groups, carbonyl groups, alkoxy groups and hydroxyl groups. Further organyl groups may include sulfur containing groups, phosphorus containing groups, boron containing groups. The subscript “a” is 0, 1, 2 or 3.

Siloxy units may be described by a shorthand (abbreviated) nomenclature, namely —“M,” “D,” “T,” and “Q”, when R is a methyl group (further teaching on silicone nomenclature may be found in Walter Noll, Chemistry and Technology of Silicones, dated 1962, Chapter I, pages 1-9). The M unit corresponds to a siloxy unit where a=3, that is R₃SiO_{1/2}; the D unit corresponds to a siloxy unit where a=2, namely R₂SiO_{2/2}; the T unit corresponds to a siloxy unit where a=1, namely R₁SiO_{3/2}; the Q unit corresponds to a siloxy unit where a=0, namely SiO_{4/2}.

Examples of typical groups on the Non-fluorinated polydiorganosiloxane polymer (A)(i) include mainly alkenyl, alkyl, and/or aryl groups. The groups may be in pendent position (on a D or T siloxy unit), or may be terminal (on an M siloxy unit). As previously indicated alkenyl and/or alkynyl groups are essential when component (C) is involved in the cure process but are optional if the sole catalyst for the cure process is component (D). Hence, when present, suitable alkenyl groups in ingredient (A)(i) typically contain from 2 to 10 carbon atoms, with preferred examples being vinyl, isopropenyl, allyl, and 5-hexenyl.

The silicon-bonded organic groups attached to ingredient (A)(i) other than alkenyl groups are typically selected from monovalent saturated hydrocarbon groups, which typically contain from 1 to 10 carbon atoms, and monovalent aromatic hydrocarbon groups, which typically contain from 6 to 12 carbon atoms, which are unsubstituted or substituted with the groups that do not interfere with curing of this inventive composition, such as halogen atoms. Preferred species of the silicon-bonded organic groups are, for example, alkyl groups such as methyl, ethyl, and propyl; and aryl groups such as phenyl.

The Non-fluorinated polydiorganosiloxane polymer may be selected from polydimethylsiloxanes, alkylmethylpolysiloxanes, alkylarylpolysiloxanes or copolymers thereof (where reference to alkyl means an alkyl group having two or more carbons) containing e.g. alkenyl and/or alkynyl groups and may have any suitable terminal groups, for example, they may be trialkyl terminated, alkenyldialkyl terminated or may be terminated with any other suitable terminal group combination providing each polymer contains at least two alkenyl groups per molecule. Hence the Non-fluorinated polydiorganosiloxane polymer may be, for the sake of example, dimethylvinyl terminated polydimethylsiloxane, dimethylvinylsiloxy-terminated dimethylmethylphenylsiloxane, trialkyl terminated dimethylmethylvinyl polysiloxane or dialkylvinyl terminated dimethylmethylvinyl polysiloxane copolymers.

The molecular structure of ingredient (A)(i) is typically linear, however, there can be some branching due to the presence of T units (as previously described) within the molecule. To achieve a useful level of physical properties in the elastomer prepared by curing the composition as hereinbefore described the molecular weight of ingredient (A)(i) should be sufficient so that it achieves a viscosity of at least 1000 mPa·s at 25° C. relying on the cup/spindle method of ASTM D 1084 Method B, using the most appropriate spindle from the Brookfield® RV or LV range for the viscosity range. The upper limit for the molecular weight of ingredient (A)(i) is not specifically restricted and is typically limited only by the processability of the LSR composition of the present.

However, (A)(i) may be a gum. A polydiorganosiloxane gum typically has a viscosity of at least 1,000,000 mPa·s at 25° C. However, because of the difficulty in measuring viscosity above these values, gums tend to be described by way of their Williams plasticity values in accordance with ASTM D-926-08 as opposed to by viscosity. Hence, a polydiorganosiloxane gum A(i) has a viscosity resulting in a Williams's plasticity of at least 30 mm/100 measured in accordance with ASTM D-926-08, alternatively at least 50 mm/100 measured in accordance with ASTM D-926-08, alternatively at least 100 mm/100 measured in accordance with ASTM D-926-08, alternatively from 100 mm/100 to 300 mm/100 in accordance with ASTM D-926-08.

Examples of ingredient (A)(i) are polydiorganosiloxanes containing alkenyl groups at the two terminals and are represented by the general formula (II):

R′R″R′″SiO—(R″R′″SiO)ₘ—SiOR′″R″R′ (II)

In formula (II), each R′ is an alkenyl group, which typically contains from 2 to 10 carbon atoms, such as vinyl, allyl, and 5-hexenyl.

R″ does not contain ethylenic unsaturation, Each R″ may be the same or different and is individually selected from monovalent saturated hydrocarbon group, which typically contain from 1 to 10 carbon atoms, and monovalent aromatic hydrocarbon group, which typically contain from 6 to 12 carbon atoms. R″ may be unsubstituted or substituted with one or more groups that do not interfere with curing of this inventive composition, such as halogen (excluding fluorine) atoms. R′″ is R′ or R″. For the avoidance of doubt, no R′″, R′ or R″ groups in component (A)(i) polymers may contain fluoro groups or any fluorine containing groups. As discussed above, when the polymer is designed to be used as part of an LSR composition, the letter m represents a degree of polymerization suitable for ingredient (A)(i) to have a viscosity of from 1,000 mPa·s to 100,000 mPa·s at 25° C. relying on the cup/spindle method of ASTM D 1084 Method B, using the most appropriate spindle from the Brookfield® RV or LV range for the viscosity range. However, if (A)(i) is in the form of a gum the value of m will be significantly greater as the viscosity thereof is >1,000,000 mPa·s at 25° C., often significantly >1,000,000 mPa·s at 25° C. and the Williams plasticity measurement is determined rather than viscosity.

Fluorinated polydiorganosiloxane polymer (A)(ii) comprises units having the formula

(R²Z)_{d}(R³)ₑSiO_{(4-d-e)/2}

wherein
each R² may be the same or different and denotes a branched or linear fluoroalkyl group having from 1 to 8 carbon atoms;
each Z may be the same or different and denotes a divalent alkylene group containing at least two carbon atoms, a hydrocarbon ether or a hydrocarbon thioether. Each R² group is linked to a silicon atom via a Z group,
each R³ is the same or different and denotes an optionally substituted saturated or unsaturated silicon-bonded, monovalent hydrocarbon group or when R³ is on a terminal group one or more R^{a}s may be —OH.
It will be appreciated that the value of d+e is a maximum of 4, but is 3 for M type groups and is 2 for D type groups wherein typically d=0 to 2, e=0 to 2 and when d is 0 at least one R³ group per unit contains one or more carbon-fluorine bonds.

Examples of suitable saturated R³ groups include alkyl groups, such as methyl, ethyl, propyl, isopropyl, butyl, hexyl, 2-ethylhexyl, octyl, isooctyl and decyl. Preferably, when e is >0 at least 90 percent, and more preferably with the exception of alkenyl groups, all of the R³ groups in the fluorosilicone polymer are methyl groups. Preferably when d is 0, on average about at least one R³ per unit contains at least one carbon-fluorine bond alternatively when e is 0, at least one R² per unit is CF₃—.

Preferably R² denotes a fluoroalkyl group having at least one carbon atom, alternatively having from 1 to 8 carbon atoms, over the complete range of from 5 to 100 mol % fluorinated siloxane units. Each fluoroalkyl group present has at least one —C—F bond. The R² groups can be identical or different and can have a normal or a branched structure. Preferably at least some, most preferably at least 50% of the fluoroalkyl groups are perfluoroalkyl groups. Examples thereof include CF₃—, C₂F₅—, C₃F₇—, such as CF₃CF₂CF₂— or (CF₃)₂CF—, C₄F₉—, such as CF₃CF₂CF₂CF₂—, (CF₃)₂CFCF₂—, (CF₃)₃C— and CF₃CF₂(CF₃)CF—; C₅F₁₁ such as CF₃CF₂CF₂CF₂CF₂—, C₆F₁₃—, such as CF₃(CF₂)₄CF₂—; C₇F₁₄—, such as CF₃(CF₂CF₂)₃—; and C₈F₁₇—.

Each perfluoroalkyl group is bonded to a silicon atom by way of Z, a divalent spacing group containing carbon, hydrogen and, optionally, oxygen and/or sulphur atoms which are present as ether and thioether linkages, respectively. The sulphur and oxygen atoms, if present, must be bonded to only carbon atoms.

Each Z radical can have any structure containing the elements listed, but is preferably an alkylene radical (i.e. an acyclic, branched or unbranched, saturated divalent hydrocarbon group). Examples of suitable alkylene radicals include —CH₂CH₂—, —CH₂CH₂CH₂—, —CH(CH₃)CH₂—, (CH₂CH₂)₂— and —CH(CH₃)CH₂CH₂—. In one embodiment each fluorinated radical, R²Z, preferably has the formula R²CH₂CH₂—, i.e. Z is an ethylene group.

As previously indicated alkenyl and/or alkynyl groups are optional but preferred in component (A)(ii) when component (C) is involved in the cure process but are optional if the sole catalyst for the cure process in component (D). Hence, when present, suitable alkenyl groups in ingredient (A)(i) typically contain from 2 to 10 carbon atoms, preferred examples include vinyl, isopropenyl, allyl, and 5-hexenyl. They may be present as terminal groups or pendant on the polymer chain.

The fluorinated polydiorganosiloxane polymer (A)(ii) may additionally comprise a proportion of up to about 90%, alternatively up to about 80% of the total number of units per molecule of non-fluorinated siloxane units having the formula

(R⁴)_{c}SiO_{(4-c)/2}

wherein R⁴ denotes an optionally substituted saturated or unsaturated silicon-bonded, monovalent hydrocarbon group, wherein c=0 to 3 but preferably the average value of c is about 2. Each R⁴ contains no fluorine (and therefore R⁴ cannot contain any of the fluoro containing substituents previously identified.

As previously indicated R⁴ denotes an optionally substituted saturated or unsaturated silicon-bonded, monovalent hydrocarbon group. Preferably each R⁴ may be the same or different and is selected from C₁ to C₁₀ alkyl groups; alkenyl groups such as vinyl or allyl groups; and/or aryl groups such as such as phenyl, tolyl, benzyl, beta-phenylethyl, and styryl. Preferably at least two R⁴ substituents per molecule are alkenyl or alkynyl groups. When present, each alkenyl group will have from 2 to 8 carbon atoms, alternatively each alkenyl group is a vinyl group.

Examples of Component (A)(ii) include copolymers of dimethylsiloxy units and (3,3,3-trifluoropropyl) methylsiloxy units; copolymers of dimethylsiloxy units, (3,3,3-trifluoropropyl)methylsiloxy units, and vinylmethylsiloxy units; copolymers of (3,3,3-trifluoropropyl)methylsiloxy units and vinylmethylsiloxy units; and poly(3,3,3-trifluoropropyl)methylsiloxane. Component (A)(ii) is trialkyl, alternatively trimethyl terminated, vinyldimethyl terminated, dimethylhydroxy terminated, and/or (3,3,3-trifluoropropyl)methylhydroxy terminated.

The molecular structure of ingredient (A)(ii) is also typically linear, however, there can be some branching due to the presence of T units (as defined above) within the molecule. To achieve a useful level of physical properties in the elastomer prepared by curing the composition as hereinbefore described, the molecular weight of ingredient (A)(ii) should be sufficient so that it achieves a viscosity of at least 1000 mPa·s at 25° C. relying on the cup/spindle method of ASTM D 1084 Method B, using the most appropriate spindle from the Brookfield® RV or LV range for the viscosity range. The upper limit for the molecular weight of ingredient (A)(ii) is also not specifically restricted. In the case when the composition is designed to make a liquid fluorosilicone rubber (F-LSR) composition the final composition is typically limited only by the processability of the F-LSR composition of the present.

However, (A)(ii) may also be a gum. As previously indicated gums typically have a viscosity of at least 1,000,000 mPa·s at 25° C. Given the difficulty in measuring viscosity above these values, they tend to be described by way of their Williams plasticity values in accordance with ASTM D-926-08 as opposed to by viscosity. When component (A)(ii) is a gum, it preferably has a viscosity resulting in a Williams's plasticity of at least 30 mm/100 measured in accordance with ASTM D-926-08, alternatively at least 50 mm/100 measured in accordance with ASTM D-926-08, alternatively at least 100 mm/100 measured in accordance with ASTM D-926-08, alternatively from 100 mm/100 to 400 mm/100 in accordance with ASTM D-926-08.

### (B) Reinforcing Filler

To achieve high level of physical properties that characterize some types of cured elastomer that can be prepared using the composition herein, it may be desirable to include a reinforcing filler (B) such as finely divided silica. Silica and other reinforcing fillers are often surface treated with one or more known filler treating agents to prevent a phenomenon referred to as “creping” or “crepe hardening” during processing of the curable composition.

Finely divided forms of silica are preferred reinforcing fillers (B), for example fumed silica, precipitated silica and/or colloidal silica. They are particularly preferred because of their relatively high surface area, which is typically at least 50 m²/g. Fillers having surface areas of from 100 to 600 m²/g measured in accordance with the BET method, alternatively of from 100 to 500 m²/g (using the BET method in accordance with ISO 9277: 2010), alternatively of from 200 to 400 m²/g (using the BET method in accordance with ISO 9277: 2010), are typically used.

The amount of finely divided silica or other reinforcing filler used in the compositions described herein is typically from about 1 to 40 weight % of the composition, alternatively 5 to 35 weight % of the composition, alternatively from 10 to 35 weight % of the composition alternatively from 15 to 35 weight % of the composition.

When the filler is naturally hydrophilic (e.g. untreated silica fillers), it is typically surface treated with a treating agent. This may be prior to introduction in the composition or in situ (i.e. in the presence of at least a portion of the other ingredients of the composition of the present invention by blending these ingredients together until the filler is completely surface treated and uniformly dispersed to for a homogeneous material). Typically, untreated filler (B) is treated in situ with a treating agent in the presence of at least one of (A)(i) and (A)(ii).

Typically the filler (B) is surface treated using for example with organosilanes, polydiorganosiloxanes, or organosilazanes, hexaalkyl disilazane, short chain siloxane diols, a fatty acid or a fatty acid ester such as a stearate to render the filler(s) hydrophobic and therefore easier to handle and obtain a homogeneous mixture with the other ingredients. Specific examples include but are not limited to liquid hydroxyl-terminated polydiorganosiloxane containing an average from 2 to 20 repeating units of diorganosiloxane in each molecule which may optionally contain fluoro groups and or fluoro containing groups, if desired, hexaorganodisiloxane, hexaorganodisilazane, and the like. A small amount of water can be added together with the silica treating agent(s) as processing aid. The surface treatment of the fillers makes them easily wetted by the polymers of component (A). These surface modified fillers do not clump and can be homogeneously incorporated into component (A) resulting in improved room temperature mechanical properties of the uncured compositions.

Typically the filler treating agent can be any low molecular weight organosilicon compounds disclosed in the art applicable to prevent creping of organosiloxane compositions during processing.

The composition is cured using a curing package of components (C)(i), (C)(ii) and optionally (C)(iii) or using component (D) or if deemed necessary a mixture of the two.

### (C)(i) Organohydrogenpolysiloxane

Ingredient (C)(i) is an organohydrogenpolysiloxane, which operates as a crosslinker for curing ingredient (A), by the addition reaction of the silicon-bonded hydrogen atoms in ingredient (C)(i) with the alkenyl groups in ingredient (A) under the catalytic activity of ingredient (C)(ii). Ingredient (C)(i) normally contains 3 or more silicon-bonded hydrogen atoms so that the hydrogen atoms of this ingredient can sufficiently react with the alkenyl groups of ingredient (A) to form a network structure therewith and thereby cure the composition. Some or all of Ingredient (C)(i) may alternatively have 2 silicon bonded hydrogen atoms per molecule when component (A) has >2 alkenyl or alkynyl, alternatively alkenyl groups per molecule.

The molecular configuration of ingredient (C)(i) is not specifically restricted, and it can be straight chain, branch-containing straight chain, or cyclic. While the molecular weight of this ingredient is not specifically restricted, the viscosity is typically from 0.001 to 50 Pa·s at 25° C. relying on the cup/spindle method of ASTM D 1084 Method B, using the most appropriate spindle from the Brookfield® RV or LV range for the viscosity range, in order to obtain a good miscibility with ingredient (A).

Ingredient (C)(i) is typically added in an amount such that the molar ratio of the total number of the silicon-bonded hydrogen atoms in ingredient (C)(i) to the total number of all alkenyl and alkynyl groups, alternatively alkenyl groups in ingredient (A) is from 0.5:1 to 20:1. When this ratio is less than 0.5:1, a well-cured composition will not be obtained. When the ratio exceeds 20:1, there is a tendency for the hardness of the cured composition to increase when heated.

Examples of ingredient (C)(i) include but are not limited to:
(i) trimethylsiloxy-terminated methylhydrogenpolysiloxane,
(ii) trimethylsiloxy-terminated polydimethylsiloxane-methylhydrogensiloxane,
(iii) dimethylhydrogensiloxy-terminated dimethylsiloxane-methylhydrogensiloxane copolymers,
(iv) dimethylsiloxane-methylhydrogensiloxane cyclic copolymers,
(v) copolymers composed of (CH₃)₂HSiO_{1/2} units and SiO_{4/2} units,
(vi) copolymers composed of (CH₃)₃SiO 1/2 units, (CH₃)₂HSiO_{1/2} units, and SiO_{4/2} units; and
(vii) copolymers containing (CH₃)₂HSiO_{1/2} units and (R²Z)_{d}(R³)ₑSiO_{(4-d-e)/2} as described above.

### (C)(ii) Hydrosilylation Catalyst

When present hydrosilylation catalyst (C)(ii), is one of the platinum metals (platinum, ruthenium, osmium, rhodium, iridium and palladium), or a compound of one or more of such metals. Platinum and platinum compounds are preferred due to the high activity level of these catalysts in hydrosilylation reactions.

Example of preferred hydrosilylation catalysts (C)(ii) include but are not limited to platinum black, platinum on various solid supports, chloroplatinic acids, alcohol solutions of chloroplatinic acid, and complexes of chloroplatinic acid with ethylenically unsaturated compounds such as olefins and organosiloxanes containing ethylenically unsaturated silicon-bonded hydrocarbon groups. The catalyst (C)(ii) can be platinum metal, platinum metal deposited on a carrier, such as silica gel or powdered charcoal, or a compound or complex of a platinum group metal.

Examples of suitable platinum based catalysts include

(i) complexes of chloroplatinic acid with organosiloxanes containing ethylenically unsaturated hydrocarbon groups are described in U.S. Pat. No. 3,419,593;
(ii) chloroplatinic acid, either in hexahydrate form or anhydrous form;
(iii) a platinum-containing catalyst which is obtained by a method comprising reacting chloroplatinic acid with an aliphatically unsaturated organosilicon compound, such as divinyltetramethyldisiloxane;
(iv) alkene-platinum-silyl complexes as described in U.S. Pat. No. 6,605,734 such as (COD)Pt(SiMeCl₂)₂ where “COD” is 1,5-cyclooctadiene; and/or
(v) Karstedt's catalyst, a platinum divinyl tetramethyl disiloxane complex typically containing about 1 wt. % of platinum in a solvent, such as toluene may be used. These are described in U.S. Pat. Nos. 3,715,334 and 3,814,730.

The hydrosilylation catalyst (C)(ii) when present, is present in the total composition in a catalytic amount, i.e. an amount or quantity sufficient to promote a reaction or curing thereof at desired conditions. Varying levels of the hydrosilylation catalyst (C)(ii) can be used to tailor reaction rate and cure kinetics. The catalytic amount of the hydrosilylation catalyst (C)(ii) is generally between 0.01 ppm, and 10,000 parts by weight of platinum-group metal, per million parts (ppm), based on the combined weight of the composition ingredients (a) and (b); alternatively between 0.01 and 5000 ppm; alternatively between 0.01 and 3,000 ppm, and alternatively between 0.01 and 1,000 ppm. In specific embodiments, the catalytic amount of the catalyst may range from 0.01 to 1,000 ppm, alternatively 0.01 to 750 ppm, alternatively 0.01 to 500 ppm and alternatively 0.01 to 100 ppm of metal based on the weight of the composition. The ranges may relate solely to the metal content within the catalyst or to the catalyst altogether (including its ligands) as specified, but typically these ranges relate solely to the metal content within the catalyst. The catalyst may be added as a single species or as a mixture of two or more different species. Typically, dependent on the form/concentration in which the catalyst package is provided the amount of catalyst present will be within the range of from 0.001 to 3.0% by weight of the composition.

### Inhibitor (C)(iii)

Mixtures of the aforementioned ingredients (A), (C)(i), and (C)(ii) may begin to cure at ambient temperature. To obtain a longer working time or pot life of a hydrosilylation cured composition when (C)(i) and (C)(ii) are present, a suitable inhibitor (C)(iii) can be used in order to retard or suppress the activity of the catalyst. Inhibitors of hydrosilylation catalysts, generally a platinum metal based catalyst are well known in the art. Hydrosilylation or addition reaction inhibitors include hydrazines, triazoles, phosphines, mercaptans, organic nitrogen compounds, acetylenic alcohols, silylated acetylenic alcohols, maleates, fumarates, ethylenically or aromatically unsaturated amides, ethylenically unsaturated isocyanates, olefinic siloxanes, unsaturated hydrocarbon monoesters and diesters, conjugated ene-ynes, hydroperoxides, nitriles, and diaziridines.

One class of known inhibitors of platinum catalysts includes the acetylenic compounds disclosed in U.S. Pat. No. 3,445,420. Acetylenic alcohols such as 2-methyl-3-butyn-2-ol constitute a preferred class of inhibitors that will suppress the activity of a platinum-containing catalyst at 25° C. Compositions containing these inhibitors typically require heating at temperature of 70° C. or above to cure at a practical rate.

Examples of acetylenic alcohols and their derivatives include 1-ethynyl-1-cyclohexanol (ETCH), 2-methyl-3-butyn-2-ol, 3-butyn-1-ol, 3-butyn-2-ol, propargylalcohol, 2-phenyl-2-propyn-1-ol, 3,5-dimethyl-1-hexyn-3-ol, 1-ethynylcyclopentanol, 1-phenyl-2-propynol, 3-methyl-1-penten-4-yn-3-ol, and mixtures thereof.

When present, inhibitor concentrations as low as 1 mole of inhibitor per mole of the metal of catalyst (C)(ii) will in some instances impart satisfactory storage stability and cure rate. In other instances, inhibitor concentrations of up to 500 moles of inhibitor per mole of the metal of catalyst (C)(ii) are required. The optimum concentration for a given inhibitor in a given composition is readily determined by routine experimentation. Dependent on the concentration and form in which the inhibitor selected is provided/available commercially, when present in the composition, the inhibitor is typically present in an amount of from 0.0125 to 10% by weight of the composition.

### (D) Peroxide Catalyst

The composition as described herein may alternatively or additionally be cured with a peroxide catalyst (D) or mixtures of different types of peroxide catalysts.

The peroxide catalyst may be any of the well-known commercial peroxides used to cure fluorosilicone elastomer compositions. The amount of organic peroxide used is determined by the nature of the curing process, the organic peroxide used, and the composition used. Typically, the amount of peroxide catalyst utilised in a composition as described herein is from 0.2 to 3% wt., alternatively 0.2 to 2% wt. in each case based on the weight of the composition.

Suitable organic peroxides are substituted or unsubstituted dialkyl-, alkylaroyl-, diaroyl-peroxides, e.g. benzoyl peroxide and 2,4-dichlorobenzoyl peroxide, ditertiarybutyl peroxide, dicumyl peroxide, t-butyl cumyl peroxide, bis(t-butylperoxyisopropyl) benzene bis(t-butylperoxy)-2,5-dimethyl hexyne 2,4-dimethyl-2,5-di(t-butylperoxy) hexane, di-t-butyl peroxide and 2,5-bis(tert-butyl peroxy)-2,5-dimethylhexane. Mixtures of the above may also be used.

When component C is relied upon to cure the composition, typically the composition will be stored in two parts, often referred to as Part A and Part B with a view to separating components (C)(i) and (C)(ii) prior to cure. Typically when present, component (C)(iii) is present in the same part as the hydrosilylation catalyst (C)(ii). Such 2 part compositions are composed to enable easy mixing immediately prior to use and are typically in a weight ratio of Part A:Part B of from 15:1 to 1:1.

### Additional Optional Ingredients

Additional optional ingredients may be present in the silicone rubber composition depending on the intended use thereof. Examples of such optional ingredients include compatibilizing agents, thermally conductive fillers, non-conductive fillers, pot life extenders, flame retardants, lubricants, non-reinforcing fillers, compression set additives, pigments coloring agents, adhesion promoters, chain extenders, silicone polyethers, and mixtures thereof.

Further examples of additives include mold release agents, diluents, solvents, UV light stabilizers, bactericides, wetting agents, heat stabilizers, compression set additives, plasticizers, and mixtures thereof.

Compatiblising agents may be introduced into the composition if deemed appropriate to assist in avoidance of phase separation between polymers (A)(i) and (A)(ii). Any suitable agent(s) may be utilised for example block, graft or random copolymers containing dimethylsilicone and methyl trifluoropropyl silicone repeat units different from (A)(ii) such as those described in U.S. Pat. No. 5,824,736.

Pot life extenders, such as triazole, may be used, but are not considered necessary in the scope of the present invention. The liquid curable silicone rubber composition may thus be free of pot life extender.

Examples of flame retardants include aluminium trihydrate, chlorinated paraffins, hexabromocyclododecane, triphenyl phosphate, dimethyl methylphosphonate, tris(2,3-dibromopropyl) phosphate (brominated tris), and mixtures or derivatives thereof.

Examples of lubricants include tetrafluoroethylene, resin powder, graphite, fluorinated graphite, talc, boron nitride, molybdenum disulfide, and mixtures or derivatives thereof.

Further additives include silicone fluids, such as trimethyl terminated or dimethylhydroxy terminated siloxanes. typically have a viscosity <150 mPa·s at 25° C. relying on the cup/spindle method of ASTM D 1084 Method B, using the most appropriate spindle from the Brookfield® RV or LV range for the viscosity range. When present such silicone fluid may be present in the liquid curable silicone rubber composition in an amount ranging of from 0.1 to 5% by weight (% wt.), based on the total weight of the composition.

Examples of pigments include titanium dioxide, chromium oxide, bismuth vanadium oxide, iron oxides and mixtures thereof.

Examples of adhesion promoters include alkoxysilane containing methacrylic groups or acrylic groups such as methacryloxymethyl-trimethoxysilane, 3-methacryloxypropyl-tirmethoxysilane, 3-methacryloxypropyl-methyldimethoxysilane, 3-methacryloxypropyl-dimethylmethoxysilane, 3-methacryloxypropyl-triethoxysilane, 3-methacryloxypropyl-methyldiethoxysilane, 3-methacryloxyisobutyl-trimethoxysilane, or a similar methacryloxy-substituted alkoxysilane; 3-acryloxypropyl-trimethoxysilane, 3-acryloxypropyl-methyldimethoxysilane, 3-acryloxypropyl-dimethyl-methoxysilane, 3-acryloxypropyl-triethoxysilane, or a similar acryloxy-substituted alkyl-containing alkoxysilane; zirconium chelate compound such as zirconium (IV) tetraacetyl acetonate, zirconium (IV) hexafluoracetyl acetonate, zirconium (IV) trifluoroacetyl acetonate, tetrakis (ethyltrifluoroacetyl acetonate) zirconium, tetrakis (2,2,6,6-tetramethyl-heptanethionate) zirconium, zirconium (IV) dibutoxy bis(ethylacetonate), diisopropoxy bis (2,2,6,6-tetramethyl-heptanethionate) zirconium, or similar zirconium complexes having β-diketones (including alkyl-substituted and fluoro-substituted forms thereof) and epoxy-containing alkoxysilanes such as 3-glycidoxypropyl trimethoxysilane, 3-glycidoxypropyl triethoxysilane, 3-glycidoxypropyl methyldimethoxysilane, 4-glycidoxybutyl trimethoxysilane, 5,6-epoxyhexyl triethoxysilane, 2-(3,4-epoxycyclohexyl) ethyltrimethoxysilane, or 2-(3,4-epoxycyclohexyl) ethyltriethoxysilane.

Examples of chain extenders include disiloxane or a low molecular weight polyorganosiloxane containing two silicon-bonded hydrogen atoms in terminal positions. The chain extender typically reacts with alkenyl groups of ingredient (A), thereby linking two or more molecules of ingredient (A) together and increasing its effective molecular weight and the distance between potential cross-linking sites.

A disiloxane is typically represented by the general formula (HR^{a}₂Si)₂O. When the chain extender is a polyorganosiloxane, it has terminal units of the general formula HR^{a}₂SiO_{1/2} and non-terminal units of the formula R^{b}₂SiO. In these formulae, R^{a} and R^{b} individually represent unsubstituted or substituted monovalent hydrocarbon groups that are free of ethylenic unsaturation and fluoro content, which include, but are not limited to alkyl groups containing from 1 to 10 carbon atoms, substituted alkyl groups containing from 1 to 10 carbon atoms such as chloromethyl, cycloalkyl groups containing from 3 to 10 carbon atoms, aryl containing 6 to 10 carbon atoms, alkaryl groups containing 7 to 10 carbon atoms, such as tolyl and xylyl, and aralkyl groups containing 7 to 10 carbon atoms, such as benzyl.

Further examples of chain extenders include tetramethyldihydrogendisiloxane or dimethylhydrogen-terminated polydimethylsiloxane.

A chain extender may be added in an amount from 1 to 10 parts by weight, based on the weight of ingredient (A), typically 1 to 10 parts per 100 parts of ingredient (A).

Examples of heat stabilizers include metal compounds such as red iron oxide, yellow iron oxide, ferric hydroxide, cerium oxide, cerium hydroxide, lanthanum oxide, copper phthocyanine. Aluminum hydroxide, fumed titanium dioxide, iron naphthenate, cerium naphthenate, cerium dimethylpolysilanolate and acetylacetone salts of a metal chosen from copper, zinc, aluminum, iron, cerium, zirconium, titanium and the like. The amount of heat stabilizer present in a composition may range from 0.01 to 1.0% weight of the total composition.

The present invention thus provides a silicone rubber composition, which comprises: Component (A) in an amount of from 40 to 95% by weight of the composition Component (B) in an amount of from 1 to 40 weight % of the composition.

When the composition is cured via hydrosilylation the composition may comprise 0.5 to 10 weight % of component (C)(i), 0.01 to 1% component (C)(ii) and from 0 to 1 weight % of component (C)(iii). In such cases the composition will be stored prior to use in two parts Part A and Part B. Typically, Part A will contain some of Component (A), some of Component (B) and Component (C)(ii) and part B will contain the remainder of components (A) and (B) together with components (C)(i) and (C)(iii) when present. The two part composition may be designed to be mixed together in any suitable ratio but typically is mixed in a ratio of part A:part B of 1 to 1.

There is also provided a method for the manufacture of a high voltage direct current insulator comprising the steps of providing a composition as described herein; mixing the composition together and curing. The mixing step may be (a) mixing all the individual ingredients together; (b) when the composition is in two parts mixing the two parts together and (c) when the composition is in 4 parts mixing the four parts together, in each case immediately prior to cure. When the composition is in two or more parts the parts are mixed together in a multi-part mixing system prior to cure.

Alternatively, when component (C) is present the composition may be preferably stored prior to use, in our parts. a first Part A containing components (A)(i), (B) and (C)(ii), a second part A containing components (A)(ii), (B) and optionally (C)(ii), a first part B containing components (A)(i), (B) and (C)(i) and (C)(iii) a second part B containing components (A)(ii), (B) and optionally (C)(i) and (C)(iii).

Alternatively, when component (C) is present component (A)(ii) the fluorinated polydiorganosiloxane may be kept separate from the ingredients of cure package (C) i.e. (C)(ii) catalyst is stored in compositions with non-fluorinated polymer (A)(i) in Part A and components (C)(i) the organohydrogenpolysiloxane and C(iii) inhibitor (if present) are stored in compositions of polymer A(i) in Part B. This enables component A(ii) the fluorinated polydiorganosiloxane to be introduced into the Part A composition and the part B composition as polymer alone or in the form of a base with filler (B). Hence, fluorinated polydiorganosiloxane polymer (A)(ii) is not mixed with crosslinker (C)(i) prior to blending with non-fluorinated polydiorganosiloxane (A)(i) in Part B and/or fluorinated polydiorganosiloxane polymer (A)(ii) is not mixed with catalyst (C)(ii) prior to blending with non-fluorinated polydiorganosiloxane (A)(i) in Part A, i.e. crosslinker (C)(i) may be solely retained in a mixture with non-fluorinated polydiorganosiloxane (A)(i) prior to blending non-fluorinated polydiorganosiloxane (A)(i) with fluorinated polydiorganosiloxane polymer (A)(ii) and/or catalyst (C)(ii) may be solely retained in a mixture with non-fluorinated polydiorganosiloxane (A)(i) prior to blending non-fluorinated polydiorganosiloxane (A)(i) with fluorinated polydiorganosiloxane polymer (A)(ii). Furthermore, fluorinated polydiorganosiloxane polymer (A)(ii) may be introduced into Part A and/or Part B as either polymer or in the form of a base with filler B.

The composition of the present invention may be prepared by combining all of ingredients at ambient or elevated temperature as desired. Any mixing techniques and devices described in the prior art can be used for this purpose. The particular device to be used will be determined by the viscosities of ingredients and the final curable coating composition. Suitable mixers include but are not limited to paddle type mixers and kneader type mixers. Cooling of ingredients during mixing may be desirable to avoid premature curing of the composition.

The order for mixing ingredients is not critical in this invention. Component (A)(i) and component (A)(ii) may be mixed together before the introduction of the other ingredients e.g. component D peroxide catalyst when present. Alternatively, a part A composition containing (A)(i) a part A composition containing (A)(ii), a part B composition containing (A)(i) and if required a part B composition containing (A)(ii) may all be prepared. Alternatively, as discussed above the Part A containing fluorinated polydiorganosiloxane polymer (A)(ii) and/or the Part B containing (A)(ii) may be optional or may consist of polymer (A)(ii) alone or a mixture of polymer (A)(ii) and reinforcing filler (B). Component B the reinforcing filler may be in any or all of these parts, as required. All four parts may then be mixed together in any order in the proportions necessary for the blend or the two parts A can be mixed together, the two part Bs can be mixed together and the Part A mixtures and part B mixtures can subsequently be mixed together. In an alternative process the various parts may be mixed together in desired ratios before injection molding using a four component mixing system.

When the composition herein is designed to be an LSR composition, the viscosity of the composition ranges of from 10 to 1,000 Pa·s, alternatively of from 10 to 500 Pa·s, alternatively of from 100 to 500 Pa·s in each case at 25° C. measured using a cone and plate rheometer at 10⁻¹ s or relying on Williams plasticity measurements for the most viscous materials where (A)(i) and/or (A)(ii) is/are gums.

The present silicone rubber composition may alternatively be further processed by injection moulding, encapsulation moulding, press moulding, dispenser moulding, extrusion moulding, transfer moulding, press vulcanization, centrifugal casting, calendering, bead application or blow moulding.

Curing of the curable silicone rubber composition may be carried out as required by the type of silicone rubber utilized. Typical curing temperatures may range of from 80 to 200° C., alternatively of from 100-170° C. The time for the cure will depend on the cure temperature and method chosen but will typically be approximately from 5 minutes to 1 hour. Furthermore, if required the resulting cured elastomers may be post cured. Any suitable post cure may be undertaken if desired. For example, the cured elastomer may be post cured in an oven at a temperature of from 150 to 250° C., alternatively of from 170° C. to 230° C. for a pre-determined period of time e.g. 2 to 10 hours as required.

Curing can for example take place in a mold to form a moulded silicone article. The composition may for example be injection moulded to form an article, or the composition can be overmoulded by injection moulding around an article or over a substrate.

There is also provided herein a high voltage direct current insulator comprising an elastomeric product of a curable silicone elastomer composition described herein and/or a high voltage direct current insulator comprising an elastomeric product obtained by curing a silicone elastomer composition as described herein. Typically, the composition contains 0 (zero) % by weight of conductive filler.

The cured product of the above described composition may be used as an insulator adapted to reduce electrical stress in high voltage direct current (HVDC) applications, i.e. power cable systems or the like. As previously indicated there is provided a high voltage direct current insulator comprising an elastomeric product of a silicone elastomer composition described herein. The high voltage direct current insulator may be used alone or may form part of an article or assembly e.g. a composite part of an assembly such as in cable accessories, as cable joint or cable termination materials, boots, sleeves and or other fittings in high voltage direct current applications, in field grading assemblies as a suitable insulating layer and in other suited cable accessories and connectors.

In a further embodiment there is provided a method for the manufacture of an insulator or a field grading assembly, comprising said insulator, for high voltage direct current (HVDC) applications, comprising the steps of: i) shaping a suitable amount of the silicone composition as hereinbefore described by an appropriate means e.g. for the sake of example by way of extrusion or using a mold and ii) curing the shaped composition to form a shaped insulator or a field grading assembly, comprising said insulator.

The high voltage direct current insulator described above may be a part of a cable accessory for high voltage direct current applications such as a cable joint, cable termination or cable connector which can e.g. seals the ends of cables having a thermoplastic or rubber cable insulation.

The present invention further provides a method for sealing and/or insulating connected cables or closing cable ends by the use of the cable joint as described before, comprising the steps of (i) providing an insulated wire having a thermoplastic or elastomer multi-layered sheath appropriate for direct current insulation and naked wire or connectors, and (ii) encapsulating naked wire or connectors by putting over onto the surface of the insulating sheath of (i) the holes of a tube-like previously moulded and cured cable joint as described before under mechanical extension of the joint in such a way that an overlap between the shaped silicone cable joint and the sheath onto the wire insulation of about more than 0.5 cm is achieved whereby the silicone cable joint seals the sheathed insulation of the insulated wire by mechanical pressure of the relaxed joint forming an encapsulating insulation also for the naked wire and connectors.

The composition as described herein may be used for the manufacture of a cable joint intended for sealing cable ends of one or more cables having a thermoplastic polyolefin or rubber cable insulation, wherein the cable joint seals cable ends of one or more cables having a thermoplastic polyolefin or rubber cable insulation.

The composition as hereinbefore described may be used in the manufacture of cable accessories, as cable joint or cable termination material in high voltage direct current applications, like for high-voltage direct current power cable applications. The cured silicone composition in accordance with the present invention can be used in the construction of all kinds of field grading assemblies, like geometric, capacitive, refractive, resistive or non-linear field grading assemblies for high voltage direct current (HVDC) applications. The cured silicone composition can be also used in field grading assemblies for high voltage direct current (HVDC) applications, where it essentially or exclusively acts in insulating layers as insulator which further contribute to electrical stress reduction in addition to the field grading materials. In certain cases, it may act also as field grading material, in particular, in resistive field grading assemblies. cable joints, cable terminal applications, cable accessories and connectors.

### EXAMPLES

Several compositions using non-fluorinated polydiorganosiloxane polymer were prepared and are identified as LSR 1, LSR 2 LSR3 and HCR 1. The LSR 1, 2 and 3 compositions are prepared in two parts as they are hydrosilylation cured. The LSR compositions are shown in Table 1a and the HCR 1 composition is shown in Table 1b below. All viscosities are given at 25° C. unless otherwise indicated. Vinyl content and Si—H content of polymers was determined by quantitative IR in accordance with ASTM E168.

TABLE 1a
Wt. % of Each Ingredient in LSR 1 and 2

| | LSR 1 | LSR 1 | LSR 2 | LSR 2 | LSR3 | LSR3 |
|---|---|---|---|---|---|---|
| | Pt A | Pt B | Pt A | Pt B | Pt A | Pt B |
| Dimethylvinyl-terminated dimethyl | 65.9 | 63.1 | 38.1 | 40.5 | 59.2 | 52.9 |
| siloxane viscosity approximately 55 | | | | | | |
| Pa.s | | | | | | |
| Dimethylvinyl-terminated dimethyl | | | 27.0 | 21.9 | 7.8 | 10.3 |
| siloxane viscosity approximately 2 | | | | | | |
| Pa.s | | | | | | |
| Dimethylvinyl-terminated dimethyl | 4.4 | 4.9 | | | | |
| methylvinyl siloxane-viscosity 370 | | | | | | |
| mPa.s, 1.16% vinyl | | | | | | |
| Treated Fumed silica surface area | 29.1 | 28.4 | 17.2 | 18.6 | 16.8 | 18.5 |
| 300m²/g (BET) with vinyl | | | | | | |
| functionalization of about 0.15 | | | | | | |
| mmol/g | | | | | | |
| Dimethylhydroxy terminated | 0.6 | 0.6 | | | | |
| polydimethyl siloxane viscosity 21 | | | | | | |
| mPa.s | | | | | | |
| Dimethylhydrogensiloxy modified | 0.0 | 2.8 | | | | |
| silica having 0.97 wt. % H as Si—H | | | | | | |
| and a viscosity of 25 mPa.s | | | | | | |
| 1-Ethynylcyclohexanol | 0.00 | 0.18 | 0.00 | 0.09 | 0.00 | 0.10 |
| Karstedt's catalyst (Platinum, 1,3- | 0.08 | 0.00 | 0.48 | 0.00 | 0.47 | 0.00 |
| diethenyl-1,1,3,3- | | | | | | |
| tetramethyldisiloxane complexes) | | | | | | |
| diluted in dimethyl vinyl terminated | | | | | | |
| siloxanes to give approximately | | | | | | |
| 0.54% by weight of Pt | | | | | | |
| Dimethylvinylated and trimethylated | | | 17.3 | 14.7 | | |
| silica | | | | | | |
| Dimethyl, methylhydrogen siloxane | | | 0 | 4.2 | 0 | 4.6 |
| with methyl silsesquioxane having | | | | | | |
| 0.81 wt. % H as SiH and a viscosity | | | | | | |
| of 15 mPa.s | | | | | | |

TABLE 1b
Wt. % of Each Ingredient in HCR 1

| | HCR 1 |
|---|---|
| Dimethylvinyl-terminated dimethyl Siloxane gum having | 48.7 |
| Williams plasticity of about 154 mm/100 having a vinyl content | |
| of 0.014% wt. | |
| Dimethylvinyl-terminated dimethyl methylvinyl Siloxane gum | 17.7 |
| having Williams plasticity of about 155 mm/100 having a vinyl | |
| content of 0.067% wt | |
| Treated Fumed silica surface area 300 m²/g (BET) - vinyl | 33.6 |
| functionalization of about 0.051 mmol/g | |

HCR 1 was cured using a peroxide catalyst, hereafter referred to as peroxide 1 which was a 45% paste of 2,5-Dimethyl-2,5-di(tert.butylperoxy)hexane in silicone. This is available commercially under a range of trade names such as DHBP-45-PSI (United Initiators). Peroxide 1 was added to the composition in an amount of 1 part per hundred parts of HCR 1.

Several compositions using fluorinated polydiorganosiloxane polymer were prepared and are identified as F-LSR 1, F-LSR 2 and FSR 1. F-LSR 1 was prepared in two parts as it is hydrosilylation cured. The compositions of F-LSR 1, F-LSR 2 are provided in Table 2a, the compositions of F-LSR 3 and F-LSR 4 are provided in Table 2b and, and the composition of FSR-1 is shown in Table 2c.

TABLE 2a
Wt. % of Each Ingredient in F-LSR 1 and 2

| | F-LSR | F-LSR | F- |
|---|---|---|---|
| | 1 Pt A | 1 Pt B | LSR-2 |
| dimethylvinyl-terminated Trifluoropropylmethyl | 72.0 | 71.0 | |
| siloxane, viscosity 59 Pa · s | | | |
| Dimethylvinylsiloxy-terminated dimethyl, | | | 68.8 |
| Trifluoropropylmethyl Siloxane (40 mol % | | | |
| trifluoropropylmethyl siloxane groups) - | | | |
| viscosity of 25 Pa · s | | | |
| Treated Fumed silica | 26.0 | 26.8 | |
| Treated Fumed silica surface area 300 m²/g | | | 31.2 |
| (BET) - with vinyl functionalization of about | | | |
| 0.16 mmol/g | | | |
| Cerium Hydrate | 1.0 | | |
| Unreactive silicone resin containing a mixture | 1.0 | | |
| of dimethylsiloxane units and phenylsilsesqui- | | | |
| oxane units, having a glass transition tempera- | | | |
| ture of about 65° C. | | | |
| Karstedt catalyst (Platinum, 1,3-diethenyl- | 0.03 | | |
| 1,1,3,3-tetramethyldisiloxane complexes) diluted | | | |
| in dimethyl vinyl terminated siloxanes to give | | | |
| approximately 0.54% by weight of Pt | | | |
| Trifluoropropyl Silsesquioxane, Dimethylhydro- | | 2.1 | |
| gensiloxy-terminated containing 0.57% SiH | | | |
| as H | | | |
| Methyl-3-butyn-2-ol | | 0.1 | |

TABLE 2b
Wt % of Each Ingredient in F-LSR 3 and 4

| | F-LSR | F-LSR | F-LSR |
|---|---|---|---|
| | 3 Pt A | 3 Pt B | 4 |
| dimethylvinyl-terminated Trifluoropropylmethyl | 67.1 | 65.1 | 66.4 |
| siloxane, viscosity 59 Pa · s | | | |
| Treated Fumed silica | 32.0 | 32.9 | 33.6 |
| Unreactive silicone resin containing a mixture | 0.9 | | |
| of dimethylsiloxane units and phenylsilsesqui- | | | |
| oxane units, having a glass transition tempera- | | | |
| ture of about 65° C. | | | |
| Karstedt catalyst (Platinum, 1,3-diethenyl- | 0.03 | | |
| 1,1,3,3-tetramethyldisiloxane complexes) | | | |
| diluted in dimethyl vinyl terminated siloxanes to | | | |
| give approximately 0.54% by weight of Pt | | | |
| Trifluoropropyl Silsesquioxane, Dimethylhydro- | | 1.9 | |
| gensiloxy-terminated containing 0.57% SiH | | | |
| as H | | | |
| Methyl-3-butyn-2-ol | | 0.06 | |

TABLE 2c
Wt % of Each Ingredient in FSR 1

| | FSR 1 |
|---|---|
| Dimethylhydroxy terminated methylvinyl, trifluoropropyl- | 49.05 |
| methyl siloxane gum having a Williams plasticity of about | |
| 300 mm/100 | |
| Fumed silica surface area 300 m²/g (BET) treated with | 33.9 |
| dimethylhydroxyl terminated trifluoropropylsiloxanes (no | |
| vinyl content) | |
| Dimethylhydroxy terminated Trifluoropropylmethyl siloxane | 16.4 |
| gum having a Williams plasticity of about 300 mm/100 | |
| Dimethylvinyl terminated dimethylmethylvinyl siloxane | 0.65 |
| having a viscosity of about 14,500 mPa · s at 25° C. and about | |
| 7.5 wt. % vinyl content groups | |

### Cured Sheets

Cured sheets were prepared at 0.5 mm or 1 mm thickness using compression molds, a hydraulic press set at 300 psi (2.068 MPa) and a temperature of 170° C. The sheets were cured for a period of 10 minutes. If desired cured sheets were suspended in vented ovens and post cured for up to 4 hours at 200° C.

Example 1—Blends of F-LSR 1 and LSR 1 were prepared using the parts by weight as shown, cured sheets prepared as described above and the volume resistivity of each cured sheet was measured. In this case sheets were not post cured.

All required part A materials were mixed together first, all required part B materials were similarly mixed together before the resulting intermediate mixtures were combined to give the final overall formulation. The blends used are indicated in Table 3a and the resulting volume resistivity results are depicted in Table 3b below.

TABLE 3a
Blends used in Example 1

| | Parts by Weight | | | |
|---|---|---|---|---|
| | | F-LSR 1 | | F-LSR 1 |
| Example | LSR 1 Part A | Part A | LSR 1 Part B | Part B |
| Comparative 1 | 100 | 0 | 100 | 0 |
| Example 1-1 | 99 | 1 | 99 | 1 |
| Example 1-2 | 97 | 3 | 97 | 3 |
| Example 1-3 | 95 | 5 | 95 | 5 |
| Example 1-3 | 95 | 5 | 95 | 5 |
| Example 1-5 | 90 | 10 | 90 | 10 |
| Example 1-6 | 80 | 20 | 80 | 20 |
| Example 1-7 | 80 | 20 | 80 | 20 |
| Example 1-8 | 70 | 30 | 70 | 30 |
| Example 1-9 | 60 | 40 | 60 | 40 |
| Comparative 2 | 0 | 100 | 0 | 100 |

Volume Resistivity (VR) Testing Volume resistivity was measured in accordance with ASTM D257-14 Standard Test Methods for DC Resistance or Conductance of Insulating Materials on cured sheets ranging in thickness from 0.5 to 2 mm using a Keithley® 8009 test cell coupled with a Keithley® 5½-digit Model 6517B Electrometer/High Resistance Meter, controlled with Model 6524 High Resistance Measurement Software. D257.

Within the Model 6524 High Resistance Measurement Software an alternating polarity test was implemented as an “Hi-R” test to minimise the effects of background currents. This is described in detail in Keithley White Paper “Improving the Repeatability of Ultra-High Resistance and Resistivity Measurements” by Adam Daire.

The Hi-R alternating polarity test was used to minimise effects of background current. This method is designed to improve high resistance/resistivity measurements which are prone to large errors due to background currents.

An Alternating Polarity stimulus voltage was used with a view to isolating stimulated currents from background currents. When the Alternating Polarity method is used, the Voltage Source output of the electrometer alternates between two voltages: Offset Voltage+Alternating V, and Offset Voltage—Alternating V, at timed intervals (the Measure Time).

A current measurement (Imeas) is performed at the end of each alternation. After four Imeas values are collected, a current reading is calculated (Icalc). Icalc is the binomially weighted average of the last four current measurements (Imeas1 through Imeas4):

Icalc=(1*Imeas1−3*Imeas2+3*Imeas3−1*Imeas4)/8

The signs used for the four terms are the polarities of the alternating portion of the voltages generating the respective currents. This calculation of the stimulated current is unaffected by background current level, slope, or curvature, effectively isolating the stimulated current from the background current. The result is a repeatable value for the stimulated current and resistance or resistivity that are calculated from it. The time dependence of the stimulated current is a material property. That is, different results will be obtained when using different Measure Times, due to material characteristics.

A Measure Time of 60 seconds was used with 3 voltage cycles typically of +1000V then −1000V. From the 6 resulting measured currents the software obtains 3 Icalc values, the 1^{st} of these are rejected and then the subsequent 2 values used to calculate VR from

VR=(Vₘₐₓ−Vₘᵢₙ)×area/(2×Icalc×Sample Thickness)

The two resulting VR values were averaged to give a final value.
For the polymer blends shown in the examples a weighted average VR was calculated based on

Calculated Blend VR=(% Mass Component A×VR component A)+(% Mass Component B×VR component B)

TABLE 3b
volume resistivity results of Example 1

| | Measured Volume | |
|---|---|---|
| Example | Resistivity Ω · cm | Calculated Blend VR |
| Comparative 1 | 1.69 × 10¹⁶ | 1.69 × 10¹⁶ |
| Example 1-1 | 1.14 × 10¹⁵ | 1.67 × 10¹⁶ |
| Example 1-2 | 4.25 × 10¹⁴ | 1.64 × 10¹⁶ |
| Example 1-3 | 2.24 × 10¹⁴ | 1.61 × 10¹⁶ |
| Example 1-3 | 3.17 × 10¹⁴ | 1.61 × 10¹⁶ |
| Example 1-5 | 2.36 × 10¹⁴ | 1.52 × 10¹⁶ |
| Example 1-6 | 2.41 × 10¹⁴ | 1.35 × 10¹⁶ |
| Example 1-7 | 2.58 × 10¹⁴ | 1.35 × 10¹⁶ |
| Example 1-8 | 3.61 × 10¹⁴ | 1.18 × 10¹⁶ |
| Example 1-9 | 2.55 × 10¹⁴ | 1.01 × 10¹⁶ |
| Comparative 2 | 1.33 × 10¹² | 1.33 × 10¹² |

It is clear that in all examples the achieved change in VR is much greater than would be predicted from the calculated blend VR.

For examples 1-2 and 1-3 a number of duplicates were measured, and the results analyzed statistically using a Student's t-test. This clearly showed that the measured difference between the means was non-zero at the 99% confidence level and thus that the volume resistivity could be well controlled within a desired range. These results are depicted in Table 3c below

TABLE 3c

| | | |
|---|---|---|
| Example 1-2 | Number of Duplicates | 4 |
| | Mean | 4.36 × 10¹⁴ |
| | Std Dev | 2.62 × 10¹³ |
| Example 1-3 | Number of Duplicates | 12 |
| | Mean | 2.65 × 10¹⁴ |
| | Std Dev | 5.30 × 10¹³ |

Example 2—Blends of F-LSR 1 and LSR 2 were prepared using the parts by weight as shown in Table 4a below.

TABLE 4a
blends used in Example 2

| | Parts by Weight | | | |
|---|---|---|---|---|
| | | F-LSR 1 | | F-LSR 1 |
| Example | LSR 2 Part A | Part A | LSR 2 Part B | Part B |
| Comparative 3 | 100 | 0 | 100 | 0 |
| Example 2-1 | 100 | 0 | 94 | 6 |
| Example 2-2 | 97 | 5 | 97 | 5 |

Cured sheets of the blends were prepared as described above and the VR was measured for each sheet using the method and equipment previously described.

TABLE 4b
Volume resistivity results for the blends in Example 2

| | Measured Volume | |
|---|---|---|
| | Resistivity Ω · cm | Calculated Blend VR |
| Comparative 3 | 1.30 × 10¹⁵ | 1.30 × 10¹⁵ |
| Example 2-1 | 3.67 × 10¹⁴ | 1.27 × 10¹⁴ |
| Example 2-2 | 2.75 × 10¹⁴ | 1.24 × 10¹⁴ |

The physical properties of Example 2-1 were also determined and compared with those of Comparative as can be seen in Table 4c below.

TABLE 4c
Mechanical properties were also measured for example
2-1 and Comparative 3

| | Example 2-1 | Comparative 3 |
|---|---|---|
| Shore A (ASTM D2240) | 40 | 40 |
| Modulus₁₀₀ MPa (ASTM D412 Die C) | 1.27 | 0.82 |
| Tensile Strength MPa (ASTM D412 | 6.4 | 7.1 |
| Die C) | | |
| Elongation at Break % (ASTM D412 | 424 | 562 |
| Die C) | | |
| Tear Die B kN/m (ASTM D624 B) | 20.6 | 24.0 |

Modulus₁₀₀ means the modulus value at 100% elongation. Example 2-1 shows that it is not necessary to add the F-LSR equally to both parts of the formulation to achieve the desired VR modification. Example 2.1 also shows that good mechanical properties can be maintained whilst achieving the desired modification of VR. Example 2-2 shows that further modification of VR can be achieved depending on formulation.

Example 3—Blends of F-LSR 2 and LSR 2 were prepared using the parts by weight as shown in Table 5a below.

TABLE 5a
blends used in Example 3

| | Parts by Weight | | | |
|---|---|---|---|---|
| | | F-LSR 2 | | F-LSR 2 |
| Example | LSR 2 Part A | Part A | LSR 2 Part B | Part B |
| Comparative 3 | 100 | 0 | 100 | 0 |
| Example 3-1 | 97.5 | 2.5 | 97.5 | 2.5 |
| Example 3-2 | 92.5 | 7.5 | 92.5 | 7.5 |
| Example 3-3 | 92.5 | 7.5 | 92.5 | 7.5 |
| Example 3-4 | 87.5 | 12.5 | 87.5 | 12.5 |
| Example 3-5 | 80 | 20 | 80 | 20 |
| Comparative 4 | | 100 | | 100 |

Cured sheets of the blends were prepared as described above and the VR was measured for each sheet using the method and equipment previously described.

TABLE 5b
Volume Resistivity results from the Blends in Example 3

| | Measured Volume | |
|---|---|---|
| | Resistivity Ω · cm | Calculated Blend VR |
| Comparative 3 | 1.17 × 10¹⁵ | 1.17 × 10¹⁵ |
| Example 3-1 | 6.29 × 10¹⁴ | 1.14 × 10¹⁵ |
| Example 3-2 | 6.90 × 10¹⁴ | 1.08 × 10¹⁵ |
| Example 3-3 | 6.75 × 10¹⁴ | 1.08 × 10¹⁵ |
| Example 3-4 | 7.93 × 10¹⁴ | 1.03 × 10¹⁵ |
| Example 3-5 | 6.70 × 10¹⁴ | 9.50 × 10¹⁴ |
| Comparative 4 | 9.05 × 10¹³ | 9.05 × 10¹³ |

It is clear that in all examples the achieved change in VR is much greater than would be predicted from the calculated blend VR. In the case of Examples 3-1 to 3-3 the measured VR is notably lower than for Example 3-4 with the lowest VR unexpectedly being observed for Example 3-1 which has the lowest level of F-LSR 2.

Mechanical properties were also measured for example 3-3 and Comparative 3 as depicted in Table 5c below.

TABLE 5c
Physical property results from Example 3

| | Example 3-1 | Comparative 3 |
|---|---|---|
| Shore A (ASTM D2240) | 49 | 40 |
| M₁₀₀ MPa (ASTM D412 Die C) | 2.42 | 0.82 |
| Tensile Strength MPa (ASTM D412 | 6.1 | 7.1 |
| Die C) | | |
| EB % (ASTM D412 Die C) | 307 | 562 |
| Tear Die B kN/m (ASTM D624 B) | 33.2 | 24.0 |
| Dielectric Strength (AC) kV/mm | 35.5 | 30.0 |
| (IEC 60243) | | |

EB means elongation at break. Example 3-3 shows good physicals with tear strength and dielectric strength actually improved over Comparative 3.

Example 4—Blends of HCR 1 and FSR 1 were prepared using the parts by weight as shown in Table 6a below. Peroxide 1 was used as the curing catalyst, 0.5 mm thick cured sheets prepared and post cured for 1 h @ 200° C. The Volume Resistivity of the resulting sheets was then measured and the results also depicted in Table 6a below.

TABLE 6a
blends and volume resistivity results from Example 4

| | | | Measured Volume | |
|---|---|---|---|---|
| Example | HCR 1 | FSR 1 | Resistivity Ω · cm | Calculated Blend VR |
| Comparative 5 | 100 | 0 | 1.94 × 10¹⁶ | 1.94 × 10¹⁶ |
| Example 4-1 | 90 | 10 | 1.88 × 10¹⁵ | 1.75 × 10¹⁶ |
| Example 4-2 | 80 | 20 | 1.26 × 10¹⁵ | 1.55 × 10¹⁶ |
| Comparative 6 | 0 | 100 | 3.86 × 10¹¹ | 3.86 × 10¹¹ |

The physical properties of the products of Example 4 were also determined as indicated in Table 6b below.

TABLE 6b
physical property results from blends in Example 4

| | Example | Example | Comparative |
|---|---|---|---|
| | 4-1 | 4-2 | 5 |
| Shore A (ASTM D2240) | 58.3 | 57.6 | 58.9 |
| M₁₀₀ MPa (ASTM D412 Die C) | 1.68 | 1.62 | 1.74 |
| Tensile Strength MPa (ASTM D412 | 10.9 | 11.4 | 12.6 |
| Die C) | | | |
| EB % (ASTM D412 Die C) | 561 | 567 | 578 |
| Tear Die B kN/m (ASTM D624 B) | 24.1 | 22.7 | 22.1 |

It is clear that in all examples the achieved change in VR is much greater than would be predicted from the calculated blend VR. The examples also show that good mechanical properties can be maintained whilst achieving the desired reduction in volume resistivity.

### Example 5

Blends of F-LSR 3 or F-LSR 4 and LSR 3 were prepared using the parts by weight as shown in Table 7a below. All required Part A blend ingredients were first mixed together, all required Part B blend ingredients were also mixed together. The example formulations were then prepared by mixing the Part A and Part B blends at a 1:1 ratio.

TABLE 7a

| | Parts by Weight | | | | | |
|---|---|---|---|---|---|---|
| | Part A Blends | | | Part B Blends | | |
| | LSR 3 | F-LSR 3 | F-LSR | LSR 3 | F-LSR 3 | F-LSR |
| Example | Part A | Part A | 4 | Part B | Part B | 4 |
| Example 5-1 (F-LSR with cure | 90 | 10 | | 90 | 10 | |
| package added) | | | | | | |
| Example 5-2 (F-LSR without cure | 80 | | 20 | 100 | | |
| package) | | | | | | |
| Example 5-3 (F-LSR without cure | 90 | | 10 | 90 | | 10 |
| package) | | | | | | |
| Example 5-4 (F-LSR without cure | 100 | | | 80 | | 20 |
| package) | | | | | | |

Cured sheets of the blends were prepared as described above, further sheets were post cured for 4 hours @ 200° C. as described above. The VR was measured for each sheet using the method and equipment previously described.

TABLE 7b
Volume Resistivity results from the Blends in Example 5

| | Measured Volume | Measured Volume |
|---|---|---|
| | Resistivity | Resistivity |
| | (cured sheets) | (post cured sheets) |
| | Ω · cm | Ω · cm |
| Example 5-1 (F-LSR with | 7.61 × 10¹³ | 8.21 × 10¹⁴ |
| cure package added) | | |
| Example 5-2 (F-LSR | 9.56 × 10¹³ | 1.46 × 10¹⁴ |
| without cure package) | | |
| Example 5-3 (F-LSR | 5.16 × 10¹³ | 1.45 × 10¹⁴ |
| without cure package) | | |
| Example 5-4 (F-LSR | 4.38 × 10¹³ | 1.60 × 10¹⁴ |
| without cure package) | | |

It is clear that for all materials there is some increase in volume resistivity after post cure, but the degree of increase is considerable reduced where F-LSR is used without the cure package. In the case of Example 5-2 the change in volume resistivity after post cure is especially low. Mechanical properties were also measured for examples after post cure for 4 h @ 200° C. as depicted in Table 7c below.

TABLE 7c
Physical property results from Example 5

| | Example | Example | Example |
|---|---|---|---|
| | 5-1 | 5-3 | 5-4 |
| Shore A (ASTM D2240) | 47.9 | 49.0 | 48.8 |
| M₁₀₀ MPa (ASTM D412 Die C) | 2.38 | 2.51 | 2.55 |
| Tensile Strength MPa (ASTM D412 | 6.7 | 6.5 | 6.2 |
| Die C) | | | |
| EB % (ASTM D412 Die C) | 430 | 400 | 370 |
| Tear Die B kN/m (ASTM D624 B) | 25.4 | 20.2 | 25.4 |

Example 5-1 shows good mechanical properties where the F-LSR includes a cure package. The results for examples 5-2 to 5-4 show that the mechanical properties are not significantly degraded when an F-LSR is used without the cure package.

1. A curable silicone elastomer composition, the composition comprising:
(A) a combination of (A)(i) and (A)(ii), wherein (A)(i) is a non-fluorinated polydiorganosiloxane present in an amount of from 50 to 99.5% by weight of component (A) and (A)(ii) is a fluorinated polydiorganosiloxane polymer present in an amount of from 0.5 to 50% by weight of component (A);
(B) at least one reinforcing filler; and
at least one of (C) or (D) wherein
(C) is at least one organohydrogenpolysiloxane (C)(i), at least one hydrosilylation catalyst (C)(ii), and optionally at least one cure inhibitor (C)(iii); or
(D) at least one peroxide catalyst;
wherein the composition contains less than or equal to 0.1% by weight of the composition of conductive filler or semi conductive filler or a mixture thereof.

2. The curable silicone elastomer composition in accordance with claim 1, wherein the composition contains zero % by weight of conductive filler.

3. The curable silicone elastomer composition in accordance with claim 1, wherein component (C) is present in the composition, and component (A)(i) and optionally component (A)(ii) contain at least two alkenyl or alkynyl groups per molecule.

4. The curable silicone elastomer composition in accordance with claim 1, wherein component (B) is surface treated with a treating agent selected from the group consisting of organosilanes, polydiorganosiloxanes, organosilazanes, hexaalkyl disilazanes, short chain siloxane diols, fatty acids, fatty acid esters, and combinations thereof, to render the filler(s) hydrophobic.

5. The curable silicone elastomer composition in accordance with claim 1, wherein component (C)(i) is present and selected from the group consisting of:
(i) trimethylsiloxy-terminated methylhydrogenpolysiloxane;
(ii) trimethylsiloxy-terminated polydimethylsiloxane-methylhydrogensiloxanes;
(iii) dimethylhydrogensiloxy-terminated dimethylsiloxane-methylhydrogensiloxane copolymers;
(iv) dimethylsiloxane-methylhydrogensiloxane cyclic copolymers;
(v) copolymers composed of (CH₃)₂HSiO_{1/2} units and SiO_{4/2} units;
(vi) copolymers composed of (CH₃)₃SiO_{1/2} units, (CH₃)₂HSiO_{1/2} units, and SiO_{4/2} units;
(vii) copolymers containing (CH₃)₂HSiO_{1/2} units and (R²Z)_{d}(R³)ₑSiO_{(4-d-e)/2}; and
(viii) combinations thereof;
wherein each R² is the same or different and denotes a branched or linear fluoroalkyl group having from 1 to 8 carbon atoms;
wherein each Z is the same or different and denotes a divalent alkylene group containing at least two carbon atoms, a hydrocarbon ether or a hydrocarbon thioether;
wherein each R³ is the same or different and denotes an optionally substituted saturated or unsaturated silicon-bonded, monovalent hydrocarbon group; and
wherein d=0 to 2, e=0 to 2, and when d is 0 at least one R³ group per unit contains one or more carbon-fluorine bonds.

6. The curable silicone elastomer composition in accordance with claim 1, wherein the composition further comprises at least one ingredient selected from the group consisting of compatibilizing agents, thermally conductive fillers, non-conductive fillers, pot life extenders, flame retardants, lubricants, non-reinforcing fillers, pigments coloring agents, adhesion promoters, chain extenders, silicone polyethers, mold release agents, diluents, solvents, UV light stabilizers, bactericides, wetting agents, heat stabilizers, compression set additives, plasticizers, and combinations thereof.

7. The curable silicone elastomer composition in accordance with claim 1, wherein component (C) is present, and the composition is stored prior to use, in either:
(i) two parts, a Part A containing components (A), (B), and (C)(ii), and a part B containing components (A), (B), (C)(i), and (C)(iii); or
(ii) four parts, a first Part A containing components (A)(i), (B), and (C)(ii), a second part A containing components (A)(ii), (B) and optionally component (C)(ii), a first part B containing components (A)(i), (B), (C)(i), and (C)(iii), and a second part B containing components (A)(ii), (B), and optionally components (C)(i) and (C)(iii).

8. The curable silicone elastomer composition in accordance with claim 7, wherein component (A)(ii) is not mixed with component (C)(i) prior to blending with component (A)(i) in Part B and/or wherein component (A)(ii) is not mixed with component (C)(ii) prior to blending with component (A)(i) in Part A.

9. A cured product of the curable silicone elastomer composition in accordance with claim 1.

10. A high voltage direct current insulator comprising, or consisting of, the cured product of claim 9.

11. A method for the manufacture of a high voltage direct current insulator, the method comprising: providing the curable silicone elastomer composition in accordance with claim 1; and mixing the composition together and curing.

12-14. (canceled)

15. The method for the manufacture of a high voltage direct current insulator in accordance with claim 11, wherein the curable silicone rubber composition is further processed by injection moulding, encapsulation moulding, press moulding, dispenser moulding, extrusion moulding, transfer moulding, press vulcanization, centrifugal casting, calendering, bead application or blow moulding.

16. The method for the manufacture of a high voltage direct current insulator in accordance with claim 11, wherein the curable silicone elastomer composition is introduced into a mold prior to cure to form a moulded silicone article.

17. The method for the manufacture of a high voltage direct current insulator in accordance with claim 11, wherein the curable silicone elastomer composition is either injection moulded to form an article or overmoulded by injection moulding around an article.

18. A high voltage direct current insulator comprising an elastomeric product of the curable silicone elastomer composition in accordance with claim 1.

19. A high voltage direct current insulator comprising an elastomeric product obtained by curing the curable silicone elastomer composition in accordance with claim 1.

20. The high voltage direct current insulator in accordance with claim 18, wherein the composition contains zero % by weight of conductive filler.

21. (canceled)

22. The A-high voltage direct current insulator in accordance with claim 18, further defined as an insulator adapted to reduce electrical stress in high voltage direct current (HVDC) applications.

23. An article or assembly comprising the high voltage direct current insulator in accordance with claim 18.

24. (canceled)

25. (canceled)

26. A cable accessory comprising the high voltage direct current insulator in accordance with claim 18.

27-29. (canceled)
